(19) United States
(12) Patent Application Publication
(10) Pub. No.: US 2015/0094878 A1
(43) Pub. Date: Apr. 2, 2015

(54) VEHICLE CONTROL APPARATUS

(71) Applicant: HONDA MOTOR CO., LTD., TOKYO (JP)

(72) Inventors: Hiroshi MIURA, WAKO-SHI (JP); Hiroaki SAWATO, WAKO-SHI (JP)

(21) Appl. No.: 14/501,185

(22) Filed: Sep. 30, 2014

(30) Foreign Application Priority Data
Oct. 2, 2013 (JP) 2013-207501

(51) Int. Cl. B60W 30/09; B60W 50/14

(52) U.S. Cl. CPC B60W 30/09; B60W 50/14; B60W 2050/146
USPC 701/1

(57) ABSTRACT

An apparatus for controlling operation of a vehicle that is communicable with a moving object through a portable terminal carried by the moving object, comprising: a receiving unit adapted to receive a moving plan of the moving object to be sent from the portable terminal, a driving plan preparing unit adapted to prepare a driving plan of the vehicle based on the received moving plan of the moving object, and an informing unit adapted to inform a driver of the vehicle of the prepared driving plan.

### BACKGROUND

1. Technical Field

An embodiment of this invention relates to a vehicle control apparatus, more specifically to a vehicle control apparatus that conducts drive control in such a manner that the vehicle recognizes position and moving plan of a moving object such as a pedestrian (human beings) and the like carrying a portable (mobile) terminal.

A vehicle control apparatus has been proposed that detects a subject (own) vehicle position and relative position to an adjacent vehicle or the like by unidirectional communication or bidirectional communication to conduct drive control for the subject vehicle, for example, in the patent reference 1 (Japanese Laid-Open Patent Application No. 2011-210250).

2. Background Art

In the technology disclosed in the patent reference 1, a relative position or the like is detected by sending/receiving a wireless signal between a mobile station mounted on other vehicle or portable terminal (wireless tag) carried by the moving object and a mobile station mounted on the subject vehicle to assist safe driving of vehicle such as collision avoidance based on the detected result.

### SUMMARY

However, in the technology disclosed in the patent reference 1, since it is not configured to transmit moving plan (intention or purpose) of the moving object such as other vehicle or pedestrian, there is a problem that it is difficult to conduct active drive control on the subject vehicle side.

In particular, since the moving object of low speed such as a pedestrian or electric wheelchair has high degree of motion freedom compared to vehicle and may pass across (traverse) a traffic lane crossing traveling direction of the vehicle. As a result, even when recognizing the positions of the moving object on the subject vehicle side, it is often difficult to predict its motion or action accurately based on the recognized positions, and it is difficult to conduct active drive control on the subject vehicle side.

Therefore, an object of this invention is to overcome the foregoing problems by providing a vehicle control apparatus that can conduct active and accurate drive control through wireless communication with a moving object such as a pedestrian.

In order to achieve the object, this invention provides in its first aspect an apparatus for controlling operation of a vehicle (10) that is communicable with a moving object (100) through a portable terminal (102) carried by the moving object (100), characterized by: a receiving unit (38, 70f1) adapted to receive a moving plan (102b1, 102b2, 102b3) of the moving object (100) to be sent from the portable terminal (102), a driving plan preparing unit (38) adapted to prepare a driving plan of the vehicle (10) based on the received moving plan of the moving object (100), and an informing unit (38, 22, 70e) adapted to inform a driver of the vehicle (10) of the prepared driving plan.

In order to achieve the object, this invention provides in its second aspect an apparatus for controlling operation of a vehicle (10) that is communicable with a moving object (100) through a portable terminal (102) carried by the moving object (100), characterized by: a receiving unit (38, 70f1) adapted to receive a moving plan (102b1, 102b2, 102b3) of the moving object (100) to be sent from the portable terminal (102), a driving plan preparing unit (38) adapted to prepare a driving plan of the vehicle (10) based on the received moving plan of the moving object (100), and a behavior controlling unit (38, 32) adapted to control behavior of the vehicle (10) based on the prepared driving plan.

In order to achieve the object, this invention provides in its third aspect a method for controlling operation of a vehicle (10) that is communicable with a moving object (100) through a portable terminal (102) carried by the moving object (100), characterized by: receiving a moving plan (102b1, 102b2, 102b3) of the moving object (100) to be sent from the portable terminal (102) (38, 70f1), preparing a driving plan of the vehicle (10) based on the received moving plan of the moving object (100) (38), and informing a driver of the vehicle (10) of the prepared driving plan (38, 22, 70e).

In order to achieve the object, this invention provides in its fourth aspect a method for controlling operation of a vehicle (10) that is communicable with a moving object (100) through a portable terminal (102) carried by the moving object (100), characterized by: receiving a moving plan (102b1, 102b2, 102b3) of the moving object (100) to be sent from the portable terminal (102) (38, 70f1), preparing a driving plan of the vehicle (10) based on the received moving plan of the moving object (100) (38), and controlling behavior of the vehicle (10) based on the prepared driving plan (38, 32).

### BRIEF DESCRIPTION OF DRAWINGS

The above and other objects and advantages of an embodiment of this invention will be more apparent from the following description and drawings in which:

FIG. 1 is a schematic diagram showing an overall view of a vehicle control apparatus according to an embodiment of this invention;

FIG. 2 is schematic diagram showing how wireless communication is performed between the portable terminal carried by a moving object and vehicle control apparatus shown in FIG. 1;

FIG. 3 is a flowchart showing operation (processing) of the portable terminal shown in FIG. 2;

FIG. 4 is an explanatory diagram showing a displaying unit of the portable terminal shown in FIG. 1;

FIG. 5 is a flowchart showing operation (processing) of the vehicle control apparatus shown in FIG. 1;

FIG. 6 is a flowchart showing a first variation by the vehicle control apparatus shown in FIG. 5; and

FIG. 7 is a flowchart showing a second variation of the vehicle control apparatus shown in FIG. 5.

### DESCRIPTION OF EMBODIMENT

An embodiment for implementing the vehicle control apparatus according to this invention will be explained with reference to the attached drawings in the following.

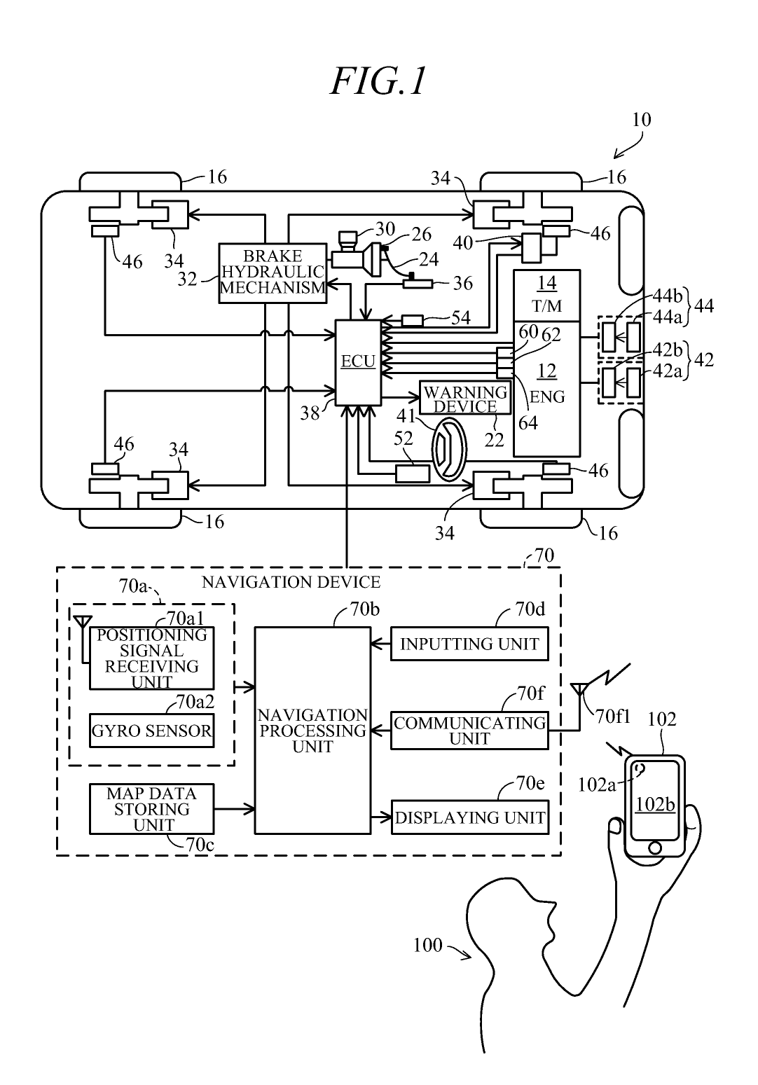

FIG. 1 is a schematic diagram showing an overall view of a vehicle control apparatus according to an embodiment of this invention.

In FIG. 1, the symbol 10 indicates a vehicle having a four-cylinder internal combustion engine (designated “ENG” in FIG. 1) 12 installed in front thereof. The output of the engine 12 is inputted to an automatic transmission (designated “TIM” in FIG. 1) 14. The automatic transmission 14 suitably changes the transmission ratio of the output of the engine 12 to transmit to wheels 16 and propels the vehicle 10.

A warning device 22 comprising an audio speaker and indicator and the like is installed at the driver's seat of the vehicle 10 for warning the driver audibly and visually. A brake pedal 24 located on the floor at the driver's seat of the vehicle 10 is connected to brakes (disk brakes) 34 installed at the individual wheels 16 through a master vac (vacuum) 26, master cylinder 30 and brake hydraulic mechanism 32.

When the driver depresses down the brake pedal 24, the depressing force is amplified by the master vac 26, and the master cylinder 30 generate braking pressure by the amplified force to operate the brake 34 installed at the individual wheels 16 through the brake hydraulic mechanism 32 so as to decelerate the vehicle 10. A brake switch 36 mounted near the brake pedal 24 outputs an ON signal when the driver depresses the brake pedal 24.

The brake hydraulic mechanism 32 has a group of electromagnetic solenoid valves interposed in oil passages connected to a reservoir (oil pan), a hydraulic pump, and an electric motor for driving the hydraulic pump and the like (none of which are shown). The group of electromagnetic solenoid valves is connected to an ECU (Electronic Control Unit) 38 through driver circuits (not shown). With this, the four brakes 34 are configured to be operated by the ECU 38 independently or separately of the depression of the brake pedal 24 by the driver.

An electric motor 40 is installed near the front wheels to assist driver's steering. Specifically, a mechanism is provided on its rack with the electric motor 40 that converts rotation of a steering wheel 41 (provided at the driver's seat) transmitted from a steering shaft and the like to reciprocating motion of a rack through a pinion to steer the front wheels via tie rods (not shown).

The electric motor 40 is also connected to the ECU 38 through a driver circuit (not shown). When an obstacle must be avoided by steering, the ECU 38 operates the electric motor 40 to assist the driver to avoid the obstacle.

The vehicle 10 is installed with a radar device 42 in front thereof. The radar device 42 detects an obstacle or moving such as a pedestrian or preceding vehicle object present in the traveling direction by transmitting an electromagnetic wave such as laser beam or millimeter wave from a radar 42a installed at a nose part and the like of the front of the vehicle 10 in the traveling direction of the vehicle 10 and receiving/processing a reflected wave of the laser beam from the obstacle or object.

The received reflected wave from the object is sent to a radar output processing unit 42b comprising a microcomputer comprising a CPU, RAM, ROM and input/output circuit. In the radar output processing unit 42b, the time from transmitting the laser beam to receiving the reflected wave is measured, and the relative distance to the object is calculated or detected from the measured time. Further the relative velocity to the object is calculated or detected by differentiating the calculated relative distance, and the direction of the object is calculated or detected from the incident direction of the reflected wave. Thus, two-dimensional information on the object is obtained.

Although not shown, the radar devices 42 are installed not only at the front body of the vehicle 10 but, for example, also at side mirrors (not shown) arranged on the right and left front of the vehicle 10 or at the rear of the vehicle 10 and the like, to detect the objects such as other vehicles or pedestrians present near the vehicle 10.

Further, the output of the radar output processing unit 42b is sent to the ECU 38. Although not shown, the ECU 38 is also configured as a microcomputer comprising a CPU, RAM, ROM and input/output circuit.

Moreover, the vehicle 10 is equipped with a photographing device 44. The photographing device 44 comprises a plurality of cameras 44a comprising a CCD camera or C-MOS camera and an image processing unit 44b. The cameras 44a are installed at plural positions of a front window, rearview mirror, side mirror, body side, rear window and the like of the vehicle 10 (only one shown in FIG. 1) to photograph around the vehicle 10. The photographed image by each camera 44a is inputted to the image processing unit 44b, and the image processing unit 44b generates image data by performing image processing such as filtering or binarization and outputs it to the ECU 38.

Wheel speed sensors 46 are installed near the respective wheels 16 to output pulse signals at every predetermined rotation angle of the wheels. A steering angle sensor 52 is installed near the steering wheel 41 p to produce output proportional to the steering angle of the steering wheel 50 inputted by driver. A yaw rate sensor 54 is installed near the center of gravity of the vehicle 10 to produce output proportional to the yaw rate (rotation angular velocity) exerted around a vertical axis (yaw axis) of the vehicle 10.

A crank angle sensor 60 is installed near a crankshaft (not shown) of the engine 12 to output a pulse signal indicating the crank angle, and a manifold absolute pressure sensor 62 is installed in an intake manifold (not shown) to output signal corresponding to the manifold absolute pressure (engine load). A throttle opening sensor 64 is installed near a throttle valve (not shown) to output corresponding to the throttle opening.

The outputs of the above mentioned sensor group are sent to the ECU 38. The ECU 38 counts the outputs of the four wheel speed sensors 46 and by averaging them, for example, detects a vehicle speed indicative of the travel speed of the vehicle 10, and measures time interval between the outputs of the crank angle sensor 60 to detect the engine speed NE.

In addition, a navigation device 70 is mounted in the vehicle 10. The navigation device 70 comprises a current position detecting unit 70a, navigation processing unit 70b, map data storing unit 70c, inputting unit 70d, displaying unit 70e and communicating unit 70f.

The current position detecting unit 70a is equipped with a positioning signal receiving unit 70a1 that receives a positioning signal such as a GPS (Global Positioning System) signal and a gyro sensor 70a2 that outputs a signal corresponding to the orientation in the horizontal plane or tilt angle to the vertical direction of the vehicle 10, and calculates the current position of the vehicle 10 by autonomous navigation based on the received positioning signal or outputs of the gyro sensor 70a2 and the above mentioned wheel speed sensors 46.

The map data storing unit 70c comprises a CD-ROM or other memory medium and stores map (road) data indicating the width, intersections, right-turn lanes and the like of the road where the vehicle 10 is traveling along. The inputting unit 70d comprises a group of switches and the like, and the displaying unit 70e is equipped with a display.

By accessing the map (road) data stored in the map data storing unit 70c, the navigation processing unit 70b operates the displaying unit 70e to display the current position of the vehicle 10 obtained by the current position detecting unit 70a and the position of the vehicle 10 inputted to the inputting unit 70d or the like.

The navigation processing unit 70b and the ECU 38 are communicably interconnected with each other, in such a way that the navigation processing unit 70b outputs to the ECU 38 information data identifying or indicating the position on the roadmap data where the vehicle 10 is driving.

A portable (mobile) terminal 102 to be carried by a moving object 100 such as a pedestrian (human being) comprises an antenna 102a for wireless communication, a display 102b for displaying a moving plan (mentioned below) of the moving object 100 on the display, and a CPU and the like (not shown) for processing these information.

The navigation device 70 of the vehicle 10 is configured to be communicable with the portable terminal 102 through an antenna 70f1 (receiving unit) of the communicating unit 70f for wireless communication and the antenna 102a of the portable terminal 102.

The ECU 38 functions as the vehicle control apparatus communicable with the moving object 100 through the portable terminal 102.

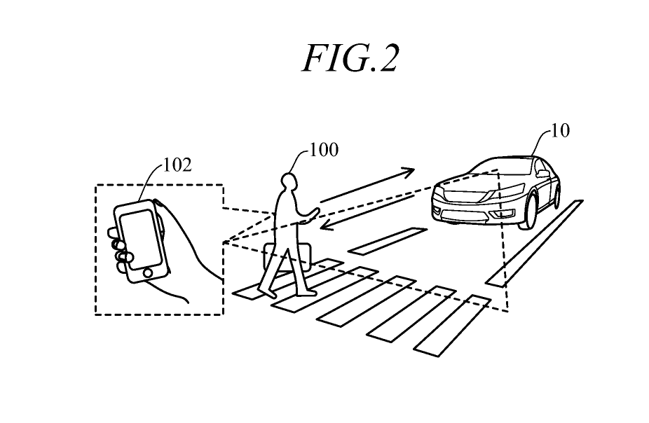

FIG. 2 is a schematic view showing wireless communication performed between the portable terminal 102 carried by the moving object 100 and vehicle control apparatus (ECU 38) according to the embodiment of this invention.

As shown in FIG. 2, the vehicle control apparatus according to the embodiment is configured such that, it receives an intention (moving plan) of the moving object 100 carrying the portable terminal 102, and controls the operation of the vehicle 10 based on the received intention, more specifically warns the driver of the presence of the moving object 100 through the warning device 22 or operates brake 34 through the brake hydraulic mechanism 32 to stop the vehicle 10.

Specifically, the vehicle control apparatus for the vehicle 10 according to the embodiment of this invention, it is configured to accurately and easily recognize the moving plan (intention) of the pedestrian and the like 100, and to conduct active and accurate drive control for the vehicle 10.

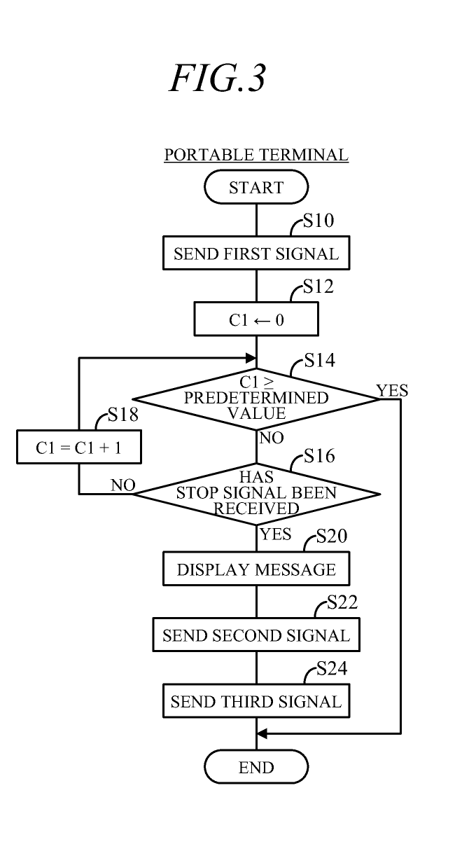

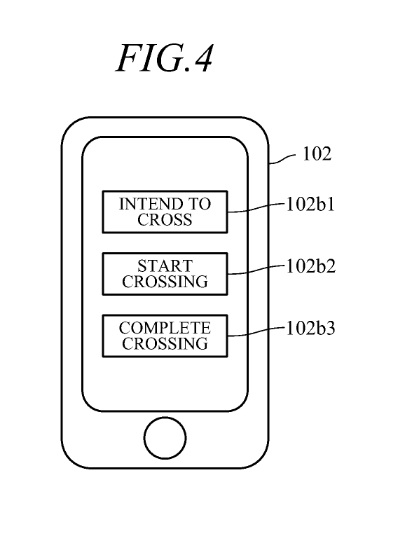

FIG. 3 is a flowchart showing operation (processing) of the portable terminal carried by the moving object 100, and FIG. 4 is an explanatory view showing a displaying unit of the portable terminal 102.

The operation is based on a situation where the moving object 100 is assumed to send a message to the vehicle 10 indicating his intention to cross the traffic lane.

Explaining this in the following, the program starts at S10 (S: Step), in which, a first signal (mentioned below) is sent to the vehicle 10, more specifically to the ECU 38 of the vehicle 10 via the antenna 102a and antenna 70f1, through manipulation of the portable terminal 102 when the moving object 100 intends to cross at the crosswalk (cross the traffic lane).

Here, the signals to be sent from the portable terminal 102 are explained with reference to FIG. 4. As shown in FIG. 4, preset moving plans of the moving object 100 such as “intend to cross” (102b1), “start crossing” (102b2), and “complete crossing” (102b3) are displayed on the display 102b of the portable terminal 102, in such a manner that the moving object 100 can appropriately selecting either of the moving plans 102b1, 102b2 and 102b3 indicated on the display 102b and sends (transmits) the selected plan (signal) to the vehicle 10.

Here, a signal to be sent to the vehicle 10 based on the moving plan of “intend to cross” (102b1) corresponds to the first signal of the above mentioned moving plans, a signal to be sent to the vehicle 10 side based on the moving plan of “start crossing” (102b2. mentioned below) corresponds to a second signal, and a signal to be sent to the vehicle 10 side based on the moving plan of “complete crossing” (102b3. mentioned below) corresponds to a third signal.

Returning to the explanation of FIG. 3 flowchart, the program next proceeds to S12, in which the value of a counter timer C1 is reset to 0, and to S14, in which it is determined whether the value of the counter timer C1 is equal to or greater than a predetermined value.

The predetermined value is set to an appropriate value for determining whether an appropriate control (stopping control) has been conducted according to the first signal received by the ECU 38 of the vehicle 10 through the antenna 70f1. Specifically, as mentioned below, since the ECU 38 of the vehicle 10 is configured to stop the vehicle 10 to return a signal to the portable terminal upon receiving the first signal sent from the portable terminal 102, when the value of the counter timer C1 has reached the predetermined value, it can be determined that the vehicle 10 has not received the first signal, or has received but fails to conduct the appropriate stopping control, for a some reason.

When the result in S14 is negative, the program proceeds to S16, in which it is determined whether a stop signal to be sent from the ECU 38 of the vehicle 10 has been received. When the result in S16 is negative, the program proceeds to S18, in which the value of the counter timer C1 is incremented by one and the program returns to S14.

Specifically, processing from S14 to S18 is repeated until the stop signal is received within a period of time before the value of the counter timer C1 reaches the predetermined value (predetermined time), or until the value of the counter timer C1 reaches the predetermined value.

Therefore, when the result in S14 is affirmative, since it can be determined that the stop signal has not been received from the ECU 38 of the vehicle 10 in the predetermined time, in other words, the vehicle 10 has not stopped, the program terminates processing.

When the result in S16 is affirmative, i.e., when the stop signal is received within the predetermined time, the program proceeds to S20, in which the display 102b of the portable terminal 102 is operated to display a message that the vehicle has stopped, and to S22, in which the second signal is sent to the ECU 38 of the vehicle 10 in response to the manipulation of the portable terminal 102 by the pedestrian and the like 100.

This means that, after confirming that the vehicle 10 has stopped by the received stop signal, the moving object 100 manipulates the portable terminal 102 to send the signal (second signal) indicating that walking (crossing) at the crosswalk is started to the ECU 38 of the vehicle 10.

When it is determined that the moving object 100 has completed crossing, the program proceeds to S24, in which the third signal is sent to the ECU 38 of the vehicle 10 in response to the manipulation of the portable terminal 102 by the moving object 100, and the program terminates processing.

As mentioned above, in the embodiment of this invention, since the ECU 38 of the vehicle 10 is configured to be able to receive the moving plan (crossing intention, first to third signal) of the moving object 100 sent from him through the portable terminal 102, it becomes possible to active and accurate drive control for the vehicle 10 based on the intention of the moving object 100.

It should further be noted in the above that, the portable terminal 102 may be configured to be equipped with a sending button or the like corresponding to all of the first to third signal, or may be configured to be equipped with only one single sending function and to switch the signal (first to third signal) to be sent to the vehicle 10 automatically based on the number of times of sending the moving plan to the vehicle 10, in other words, to change the moving plan 102b1, 102b2, 102b3 to be sent based on the number of times of sending the moving plan to the vehicle 10.

And the portable terminal 102 may be configured to display the moving plan 102b1, 102b2, 102b3 one by one in a predetermined order, in other words, change the moving plan 102b1, 102b2, 102b3 to be displayed on the displaying unit 102b in a predetermined order.

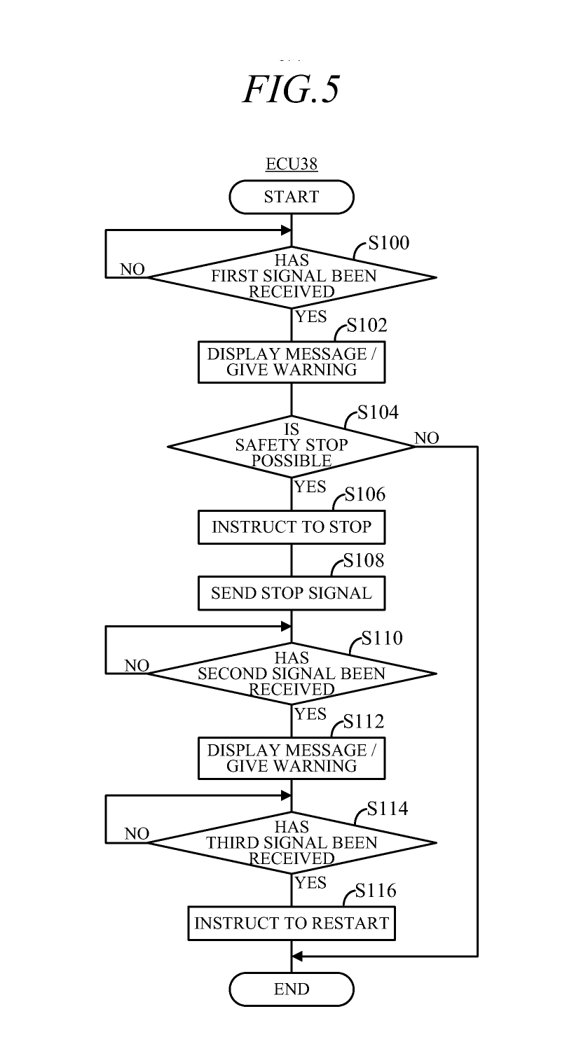

FIG. 5 is a flowchart showing operation of the vehicle control apparatus, i.e., processing by the ECU 38 of the vehicle 10 that is performed in cooperation with the above mentioned processing of the portable terminal 102.

Explaining this in the following, the program starts at S100, in which it is determined whether the first signal sent from the portable terminal 102 has been received. It should be noted that, subsequent processing is not performed until the first signal is received and the result in S100 becomes affirmative.

When the result in S100 is affirmative, the program proceeds to S102, in which a message such as, for example, “PEDESTRIAN INTEND TO CROSS AHEAD” is displayed on the displaying unit 70e provided on the navigation device of the vehicle 10, and the similar audible warning or the like is gave to the driver of the vehicle 10 using the warning device 22.

The program next proceeds to S104, in which it is determined whether it is possible to stop the vehicle 10 safely. Specifically, it is determined whether it is possible to stop the vehicle 10 safely based on a current vehicle speed and distance to the crosswalk at which the moving object 100 intends to cross and the like.

When it is determined that it is not possible to stop the vehicle 10 safely, the result in S104 becomes negative and the program terminates processing. It should be noted that, in this case, a signal indicating that the vehicle 10 can not stop may be sent to the portable terminal 102 of the moving object 100.

On the other hand, when it is determined that it is possible to stop the vehicle 10 safely, the program proceeds to S106, in which an instruction to stop the vehicle 10 is sent to the driver through the displaying unit 70e and warning device 22, or a direct instruction is sent to the brake hydraulic mechanism 32 to operate the brake 34 installed at the individual wheels 16 to stop the vehicle 10.

When the vehicle 10 has stopped, the program next proceeds to S108, in which the stop signal indicating that the vehicle 10 has stopped is sent to the portable terminal 102 of the moving object 100 through the antenna 70f1. It should be noted that, this stop signal sent from the ECU 38 corresponds to the stop signal received by the portable terminal 102 in processing of S16 in the FIG. 3 flowchart.

The program next proceeds to S110, in which it is determined whether the second signal to be sent from the moving object 100 through the portable terminal 102 (S22) has been received. When the result is negative, the determination is repeated until the result becomes affirmative, i.e., the second signal is received.

When the second signal is received, the program proceeds to S112, in which a message such as, for example, “PEDESTRIAN CROSSING” is displayed on the displaying unit 70e, and the similar audible warning or the like is gave to the driver of the vehicle 10 using the warning device 22. Further, during this time, restarting of the vehicle 10 is inhibited.

The program next proceeds to S114, in which it is determined whether the third signal to be sent from the moving object 100 through the portable terminal 102 (S24) has been received, in other words, the vehicle 10 is waited and stopped until the third signal is received so that it can be determined that the moving object 100 has completed crossing.

When the result in S114 is affirmative and it is determined that the moving object 100 has completed crossing at the crosswalk, the program proceeds to S116, in which restarting of the vehicle 10 is instructed to the driver through the displaying unit 70e and warning device 22, and the program terminates processing. It should be noted that, when the vehicle 10 should drive automatically, the vehicle 10 is restarted by an instruction from the ECU 38.

As mentioned above, in the embodiment of this invention, the ECU 38 of the vehicle 10 can conduct active and accurate drive control for vehicle based on the moving plan (crossing intention) of the moving object 100 sent through the portable terminal 102. It should be noted that, the above mentioned processing shown in S100 to S116, more correctly processing shown in S104 to S106, S110 to S116 corresponds to a driving plan preparing unit.

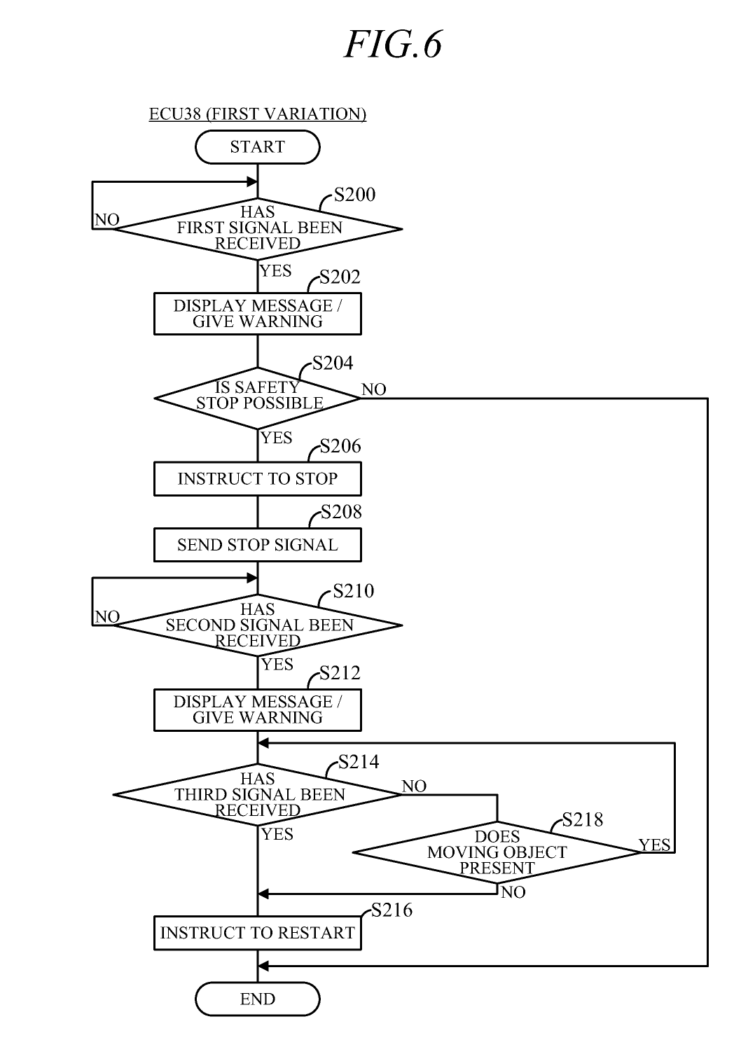

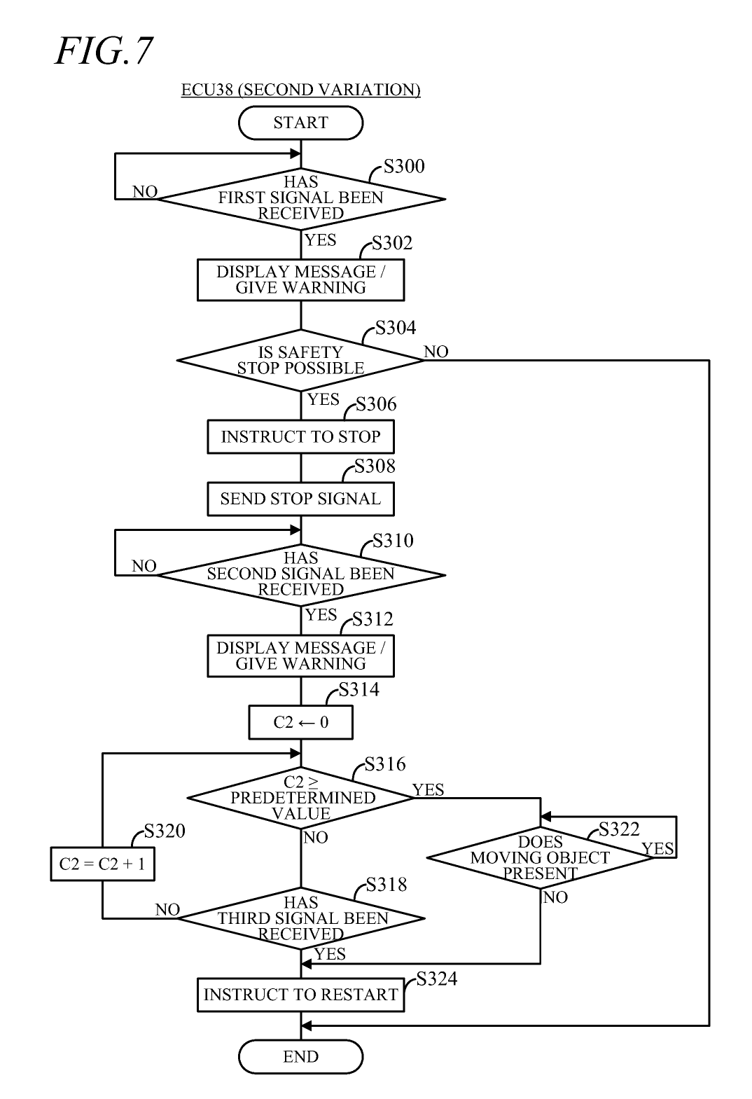

FIG. 6 and FIG. 7 are flowcharts showing variations of processing of the ECU 38 of the above mentioned vehicle 10.

First, explaining a first variation shown in FIG. 6, processing in S200 to S214 is the same as in S100 to S114.

When the result in S214 is affirmative, the program proceeds to S216, in which, similarly to in S116, restarting of the vehicle 10 is instructed to the driver, and the program terminates processing. On the other hand, when the result in S214 is negative, the program proceeds to S218, in which it is determined whether the moving object 100 presents on the crosswalk using the radar device 42 and photographing device 44.

When the result in S218 is affirmative, since it is determined that the moving object 100 is crossing, the program returns to S214 and repeats the above mentioned processing.

On the other hand, when the result in S218 is negative, i.e., it is determined that the moving object 100 has completed crossing and the safety is confirmed, the program proceeds to S216, in which restarting of the vehicle 10 is instructed to the driver, and the program terminates processing.

Specifically, since there can be cases where the moving object 100 has completed crossing but fails to send the third signal and goes away, in this variation, it is configured to determine whether the moving object 100 has completed crossing through the radar device 42 and photographing device 44 even when the ECU 38 has not received the third signal, to make it possible to restart the vehicle 10 immediately when it can be determined that crossing has been completed.

Next, explaining a second variation shown in FIG. 7. In the second variation, processing in S300 to S312 is the same as in S100 to S112 and S200 to S212.

In S314, the value of a counter timer C2 is reset to 0, and the program proceeds to S316, in which it is determined whether the value of the counter timer C2 is equal to or greater than a predetermined value.

The predetermined value is set to a value corresponding to a time considered to be required from starting crossing to completing crossing by the moving object 100 (predetermined time). Specifically, in this variation, by determining whether the predetermined time has elapsed after receiving the second signal from the moving object 100 through the portable terminal 102, it becomes possible to restart the vehicle 10 immediately even when the moving object 100 fails to send the third signal or the like.

However, since the predetermined time is set to give enough time to the moving object 100 to complete crossing, the third signal can be received before the predetermined time elapses. Therefore, even when the result in S316 is negative, the program proceeds to S318, in which, similarly to in S114 or S214, it is determined whether the third signal is received.

When the result in S318 is affirmative, the program proceeds to S320, in which restarting of the vehicle 10 is instructed to the driver, while when the result in S318 is negative, the program proceeds to S320, in which the value of the counter timer C2 is incremented by one, and returns to S316.

When the result in S316 is affirmative and it is determined that the predetermined time has elapsed, the program proceeds to S322, in which, as in S218, it is determined whether the moving object 100 presents on the crosswalk using the radar device 42 or photographing device 44.

When the result in S322 is affirmative, the program waits until it can be determined that the moving object 100 has completed crossing and the safety is confirmed by the radar device 42 and photographing device 44, while when the result in S322 is negative, the program proceeds to S324, in which restarting of the vehicle 10 is instructed, and the program terminates processing.

As stated above, the embodiment of this invention is configured to have an apparatus or method for controlling operation of a vehicle (10) that is communicable with a moving object (pedestrian or the like 100) through a portable terminal (102) carried by the moving object (pedestrian and the like 100), comprising: a receiving unit (ECU 38, antenna 70f1, S100, S110, S114, S200, S210, S214, S300, S310, S318) adapted to receive a moving plan (102b1, 102b2, 102b3, first to third signal) of the moving object (pedestrian and the like 100) to be sent from the portable terminal (102), a driving plan preparing unit (ECU 38, S104 to S106, S110 to S116, S204 to S206, S210 to S216, S218, S304 to S306, S310 to S324) adapted to prepare a driving plan of the vehicle (10) based on the received moving plan of the moving object (pedestrian and the like 100), and an informing unit (ECU 38, warning device 22, displaying unit 70e, S106, S112, S116, S206, S212, S216, S306, S312, S324) adapted to inform a driver of the vehicle (10) of the prepared driving plan. With this, it becomes possible to recognize the moving plan of the pedestrian and the like 100 on the vehicle 10 side, thereby enabling active and accurate drive control for vehicle 10 based on the moving plan of the pedestrian and the like 100.

In particular, when the moving object 100 comprises a low speed moving object such as a pedestrian or electric wheelchair, since it has high flexibility of motion relative to the vehicle 10 and may, not only move along the sidewalk but also, cross the traffic lane, even when recognizing the position of the pedestrian and the like 100 on the vehicle 10 side, it is often difficult to predict the action accurately only based on the recognized position, and it is difficult to conduct active and accurate drive control on the subject vehicle side. However, in the vehicle control apparatus (ECU 38) according to the embodiment of this invention, it is configured to receive the moving plan 102b1, 102b2, 102b3 (first to third signal), more specifically the action intention of the pedestrian and the like 100 through the portable terminal 102 carried by the pedestrian and the like (moving object) 100. With this, it becomes possible to recognize the action intention (moving plan) of the pedestrian and the like 100 easily, thereby enabling active and accurate drive control on the vehicle 10 side.

The embodiment of this invention is configured to have an apparatus or method for controlling operation of a vehicle (10) that is communicable with a moving object (pedestrian or the like 100) through a portable terminal (102) carried by the moving object (pedestrian and the like 100), comprising: a receiving unit (ECU 38, antenna 70f1, S100, S110, S114, S200, S210, S214, S300, S310, S318) adapted to receive a moving plan (102b1, 102b2, 102b3, first to third signal) of the moving object (pedestrian and the like 100) to be sent from the portable terminal (102), a driving plan preparing unit (ECU 38, S104 to S106, S110 to S116, S204 to S206, S210 to S216, S218, S304 to S306, S310 to S324) adapted to prepare a driving plan of the vehicle (10) based on the received moving plan of the moving object (pedestrian and the like 100), and a behavior controlling unit (ECU 38, brake hydraulic mechanism 32, S106, S116, S206, S216, S306, S324) adapted to control behavior of the vehicle (10) based on the prepared driving plan. With this, in addition to the effects and advantages mentioned above, it becomes possible to conduct active and accurate drive control for vehicle 10 based on the moving plan of the pedestrian and the like 100 even when conducting automatic travel operation control.

In the apparatus and method, the moving plan of the moving object (pedestrian and the like 100) to be sent from the portable terminal (102) includes at least a road crossing intention (102b1) of the moving object (pedestrian and the like 100). With this, in addition to the effects and advantages mentioned above, it becomes possible to conduct drive control for the vehicle 10 to stop the vehicle 10 based on the crossing intention of the pedestrian and the like 100.

In the apparatus and method, the portable terminal (102) is adapted to send one moving plan selected from among a plurality of preset moving plans (102b1, 102b2, 102b3). With this, in addition to the effects and advantages mentioned above, it becomes possible to recognize the moving plan of the pedestrian and the like 100 more accurately and easily, thereby enabling more active and accurate drive control for vehicle 10 based on the moving plan of the pedestrian and the like 100.

In the apparatus and method, the portable terminal (102) is adapted to have a plurality of preset moving plans (102b1, 102b2, 102b3), and to change the moving plan to be sent based on the number of times of sending the moving plan to the vehicle (10). With this, in addition to the effects and advantages mentioned above, it becomes possible to recognize the moving plan of the pedestrian and the like 100 more accurately and easily, thereby enabling more active and accurate drive control for vehicle 10 based on the moving plan of the pedestrian and the like 100.

In the apparatus and method, the portable terminal (102) is adapted to have a plurality of preset moving plans (102b1, 102b2, 102b3), and to change the moving plan in a predetermined order. With this, in addition to the effects and advantages mentioned above, it becomes possible to recognize the moving plan of the pedestrian and the like 100 more accurately and easily, thereby enabling more active and accurate drive control for vehicle 10 based on the moving plan of the pedestrian and the like 100.

In the apparatus and method, the portable terminal (102) is adapted to have a display (displaying unit 102b) that displays the moving plan to be sent. With this, in addition to the effects and advantages mentioned above, it becomes possible to select and send accurate moving plan appropriately and easily on the pedestrian and the like 100 side, thereby enabling more active and accurate drive control for vehicle 10.

It should be noted in the above that, although not shown, an ultrasonic sonar or millimeter wave radar can be installed on the vehicle 10 to detect the moving object or obstacle present around the vehicle 10 similar to the radar device 42 and photographing device 44.

It should further be noted that, although it is mentioned in the embodiment that a millimeter wave radar or ultrasonic sonar and the like may be used in addition to the radar device 42 and photographing device 44, it is sufficient to detect the moving object 100 presents around the vehicle 10, all of these are not always required to be equipped. Moreover, the number or arrangement of the radar 42a and cameras 44a should not be limited to that of the above mentioned embodiment.

It should further be noted that, in the embodiment, a pedestrian is explained as an example of the moving object 100, the moving object 100 should not be limited to this, and it may be, for example, an electric wheelchair, any other vehicle or the like.

It should further be noted that, the portable terminal 102 may be any device using GPS to calculate own current position, and, in addition to the first to third signals indicating the moving plan of the moving object 100, a signal indicating the current position of the portable terminal 102 may be included into the signal sent from the portable terminal 102. In this case, the ECU 38 may be configured to calculate relative position or the like between the vehicle 10 and the moving object 100 based on the current position signal sent from the portable terminal 102 and the current position information of the vehicle 10 calculated by the current position detecting unit 70a.

Japanese Patent Application No. 2013-207501, filed on Oct. 2, 2013, is incorporated by reference herein in its entirety.

While the invention has thus been shown and described with reference to a specific embodiment, it should be noted that the invention is in no way limited to the details of the described arrangements; changes and modifications may be made without departing from the scope of the appended claims.

What is claimed is:

1. An apparatus for controlling operation of a vehicle that is communicable with a moving object through a portable terminal carried by the moving object, comprising:
a receiving unit adapted to receive a moving plan of the moving object to be sent from the portable terminal,
a driving plan preparing unit adapted to prepare a driving plan of the vehicle based on the received moving plan of the moving object, and
an informing unit adapted to inform a driver of the vehicle of the prepared driving plan.

2. An apparatus for controlling operation of a vehicle that is communicable with a moving object through a portable terminal carried by the moving object, comprising:
a receiving unit adapted to receive a moving plan of the moving object to be sent from the portable terminal,
a driving plan preparing unit adapted to prepare a driving plan of the vehicle based on the received moving plan of the moving object, and
a behavior controlling unit adapted to control behavior of the vehicle based on the prepared driving plan.

3. The apparatus according to claim 1, wherein the moving plan of the moving object to be sent from the portable terminal includes at least a road crossing intention of the moving object.

4. The apparatus according to claim 2, wherein the moving plan of the moving object to be sent from the portable terminal includes at least a road crossing intention of the moving object.

5. The apparatus according to claim 1, wherein the portable terminal is adapted to send one moving plan selected from among a plurality of preset moving plans.

6. The apparatus according to claim 2, wherein the portable terminal is adapted to send one moving plan selected from among a plurality of preset moving plans.

7. The apparatus according to claim 1, wherein the portable terminal is adapted to have a plurality of preset moving plans, and to change the moving plan to be sent based on the number of times of sending the moving plan to the vehicle.

8. The apparatus according to claim 2, wherein the portable terminal is adapted to have a plurality of preset moving plans, and to change the moving plan to be sent based on the number of times of sending the moving plan to the vehicle.

9. The apparatus according to claim 1, wherein the portable terminal is adapted to have a plurality of preset moving plans, and to change the moving plan in a predetermined order.

10. The apparatus according to claim 2, wherein the portable terminal is adapted to have a plurality of preset moving plans, and to change the moving plan in a predetermined order.

11. The apparatus according to claim 1, wherein the portable terminal is adapted to have a display that displays the moving plan to be sent.

12. A method for controlling operation of a vehicle that is communicable with a moving object through a portable terminal carried by the moving object, comprising the steps of:
receiving a moving plan of the moving object to be sent from the portable terminal,
preparing a driving plan of the vehicle based on the received moving plan of the moving object, and
informing a driver of the vehicle of the prepared driving plan.

13. A method for controlling operation of a vehicle that is communicable with a moving object through a portable terminal carried by the moving object, comprising the steps of:
receiving a moving plan of the moving object to be sent from the portable terminal,
preparing a driving plan of the vehicle based on the received moving plan of the moving object, and
controlling behavior of the vehicle based on the prepared driving plan.

14. The method according to claim 12, wherein the moving plan of the moving object to be sent from the portable terminal includes at least a road crossing intention of the moving object.

15. The method according to claim 13, wherein the moving plan of the moving object to be sent from the portable terminal includes at least a road crossing intention of the moving object.

16. The method according to claim 12, wherein the portable terminal is adapted to send one moving plan selected from among a plurality of preset moving plans.

17. The method according to claim 13, wherein the portable terminal is adapted to send one moving plan selected from among a plurality of preset moving plans.

18. The method according to claim 12, wherein the portable terminal is adapted to have a plurality of preset moving plans, and to change the moving plan to be sent based on the number of times of sending the moving plan to the vehicle.

19. The method according to claim 13, wherein the portable terminal is adapted to have a plurality of preset moving plans, and to change the moving plan to be sent based on the number of times of sending the moving plan to the vehicle.

20. The method according to claim 12, wherein the portable terminal is adapted to have a plurality of preset moving plans, and to change the moving plan in a predetermined order.

21. The method according to claim 13, wherein the portable terminal is adapted to have a plurality of preset moving plans, and to change the moving plan in a predetermined order.

22. The method according to claim 12, wherein the portable terminal is adapted to have a display that displays the moving plan to be sent.
